(19) United States
(12) Patent Application Publication
(10) Pub. No.: US 2017/0142777 A1
(43) Pub. Date: May 18, 2017

(54) MODIFYING INACTIVITY TIMERS FOR USER EQUIPMENT IN A WIRELESS COMMUNICATION SYSTEM

(71) Applicant: Alcatel-Lucent USA Inc., Murray Hill, NJ (US)

(72) Inventors: Subba Rao V. Vuppala, Marlborough, MA (US); Said Soulhi, Boston, MA (US)

(21) Appl. No.: 14/940,759

(22) Filed: Nov. 13, 2015

(51) Int. Cl. H04W 76/06; H04W 76/04

(52) U.S. Cl. CPC H04W 76/068; H04W 76/046

(57) ABSTRACT

A user equipment transmits a request to modify a duration of an inactivity timer associated with the user equipment and the types of bearers being used by the application layer (e.g., a VoLTE client or an MTC client). A base station receives the request to modify the duration of the inactivity timer and transmits a confirmation indicating that the duration of the inactivity timer has been modified. The user equipment receives the confirmation indicating that the duration of the inactivity timer has been modified.

### BACKGROUND

Field of the Disclosure

The present disclosure relates generally to wireless communication systems and, more particularly, to inactivity timers in wireless communication systems.

Description of the Related Art

Wireless communication systems include packet-switched data networks that can support applications such as voice calls, video streaming, or other multimedia applications. For example, wireless communication systems that operate according to the Long Term Evolution (LTE) standards defined by the Third Generation Partnership Project (3GPP) may support voice calls between different user equipment using Voice-over-Internet-Protocol (VoIP) or Voice-over-LTE (VoLTE) applications. To establish a voice call between first and second user equipment, the first user equipment and the second user equipment form a network layer connection via the data network, such as a radio resource control (RRC) connection. The network then verifies that the requested voice call is supported for the first and second user equipment, e.g., by accessing user profiles associated with the first and second user equipment in home subscriber servers (HSSs) deployed in an Internet Multimedia Subsystem (IMS) network or an Evolved Packet Core (EPC) network. The call is established in response to the network verifying that the requested voice call is supported and a message is transmitted to the second user equipment to initiate ringing (or other user-detectable signal) to alert the user that the call has been established.

Radio Access Networks (RANs) implement inactivity timers for each user equipment that has an active connection, e.g., user equipment that are in the RRC connected state. Inactivity timers may be implemented in base stations or eNodeBs that operate according to the Evolved Universal Terrestrial Radio Access Network (E-UTRAN) standards that define the air interface according to LTE. The inactivity timer for a user equipment is reset each time the user equipment transmits a message over the air interface to the base station and then the inactivity timer begins counting down. The user equipment exits the RRC connected state in response to its inactivity timer expiring. Conventional data networks configure the inactivity timers for all user equipment to have the same value for different bearer types or single value per bearer type, e.g., 60 seconds. These values are provisioned to base stations or eNodeBs in the RAN.

However, using a network-centric solution and a single value per bearer type for all the inactivity timers has a number of drawbacks. For example, the delay between a first user equipment initiating a call to a second user equipment (and thereby resetting both of their inactivity timers) and the second user equipment accepting the call by transmitting a message (and thereby resetting its activity timer) may exceed the duration of the inactivity timer. If this occurs, the second user equipment leaves the RRC connected state and the call may be dropped, which can lead to degradation of key performance indicators (KPIs) in the network.

The eUTRAN may also drop the call in response to the inactivity timer expiring before user equipment have completed negotiations to set up a dedicated bearer for the call. For example, a first user equipment may initiate establishment of a dedicated bearer for a multimedia application such as VoLTE. The eUTRAN starts an inactivity timer for a default data bearer in response to the first user equipment initiating the process for establishing the dedicated bearer. The duration of an inactivity timer for a default data bearer is usually set at a low value such as 5 seconds. In contrast, the typical duration of an inactivity timer for a dedicated bearer is 20 seconds. The time required to negotiate the dedicated bearer for voice or multimedia applications such as VoLTE may exceed the duration of the inactivity timer for a default data bearer because of the additional time that elapses while the network verifies that it supports the application for the first and second user equipment. The eUTRAN is not aware that a dedicated bearer has been allocated until it receives a response from the second user equipment and the second user equipment does not send the response until the dedicated bearer has been established. The eUTRAN continues to count down the inactivity timer for the default data bearer until the eUTRAN receives a trigger to allocate the dedicated bearer based on the response from the second user equipment. The eUTRAN may therefore drop the RRC connection state (move to idle) due to timer expiry for the default bearer before negotiation of the dedicated bearer is complete.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a wireless communication system according to some embodiments.

FIG. 2 is a diagram illustrating an extension request message that is used to request a modification of an inactivity timer according to some embodiments.

FIG. 3 is a diagram illustrating an exchange of an extension request and an acknowledgment according to some embodiments.

FIG. 4 is a block diagram of a wireless communication system that supports wireless communication over an air interface according to some embodiments.

### DETAILED DESCRIPTION

The drawbacks of implementing a single duration for the inactivity timers (globally or per quality-of-service (QoS) class identifier (QCI)) in a wireless communication system may be reduced by modifying the air interface to support a message exchange between user equipment and base stations that allows the user equipment to transmit a request to modify a duration of its associated inactivity timer depending on the applications being used and event triggers for the user equipment, e.g. to increase an inactivity timer for a specific MTC application within a certain interval of time. The base station can respond with another message acknowledging that the requested modification has been performed. The base station resets the inactivity timer in response to receiving the request from the user equipment and modifies the duration of the inactivity timer based on an offset value included in the request. For example, the inactivity timer may initially be set to a default value, such as 60 seconds. The user equipment may then request a modification to increase or decrease the duration of the inactivity timer by an offset value of an additional 60 seconds. The base station resets the inactivity timer for the user equipment to a value of 120 seconds in response to receiving the request. Some embodiments of the user equipment may request a decreased value of the inactivity timer by transmitting a negative value of the offset. The user equipment may select the value of the offset based on the application that is using the connection to the data network. For example, different offsets may be selected by a VoLTE client, a Machine Type Communication (MTC) client, or other applications.

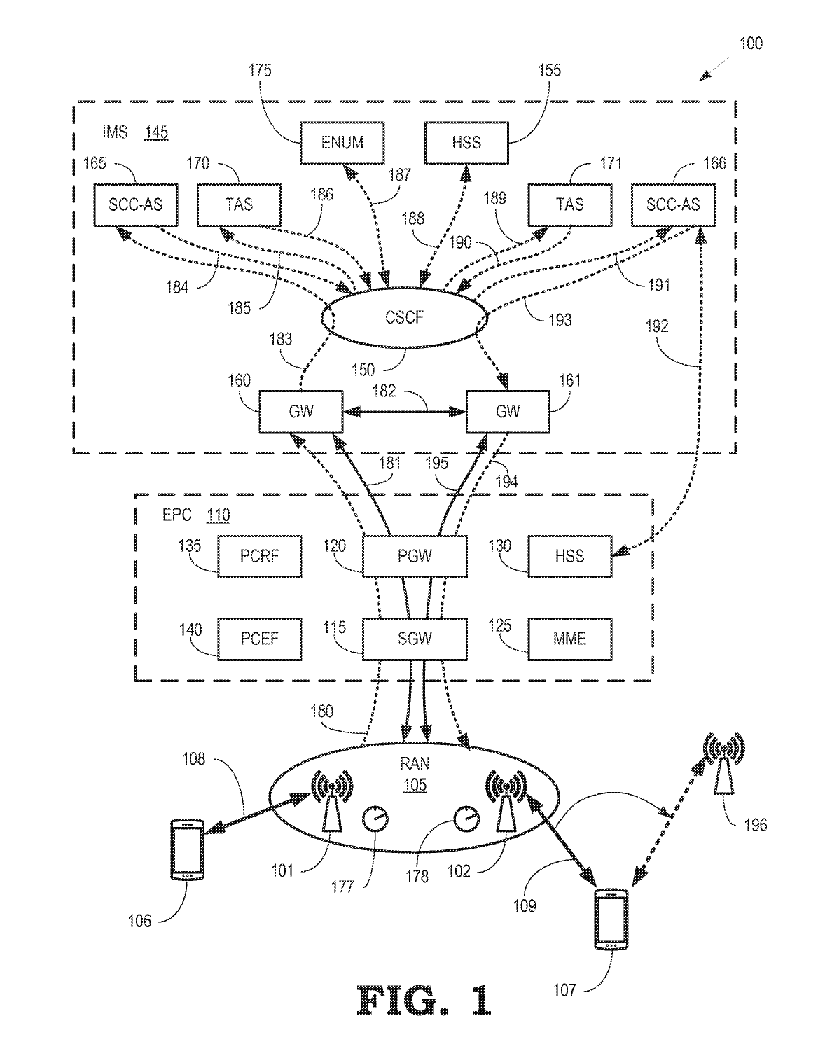

FIG. 1 is a diagram of a wireless communication system 100 according to some embodiments. The wireless communication system 100 includes one or more base stations 101, 102 that provide wireless connectivity according to one or more radio access technologies, e.g., according to the Long Term Evolution (LTE, LTE-A) standards defined by the Third Generation Partnership Project (3GPP). As used herein, the term “base station” may be used to refer to eNodeBs, base station routers, access points, and the like. The base stations 101, 102 are part of a radio access network (RAN) 105 such as an eUTRAN. The base stations 101, 102 may be used to provide wireless connectivity to user equipment 106, 107 over corresponding air interfaces 108, 109. Although two base stations 101, 102 are used to connect the corresponding user equipment 106, 107 to the RAN 105 (and other networks), the user equipment 106, 107 (or other user equipment) may be connected to a single base station in some embodiments.

The RAN 105 is connected to a core network such as an evolved packet core (EPC) 110 that operates according to the LTE standards. In the illustrated embodiment, the RAN 105 is connected to a gateway in the EPC 110 such as a serving gateway (SGW) 115. Some embodiments of the SGW 115 route and forward user data packets and act as a mobility anchor for the user plane during handovers between base stations such as the base stations 101, 102 or other base stations in the wireless communication system 100. The SGW 115 may terminate the downlink data path for user equipment that are in the idle mode and may trigger paging when downlink data arrives for the idle user equipment. The SGW 115 may also manage and store contexts that include parameters to define the Internet Protocol (IP) bearer service for user equipment. The SGW 115 is connected to a packet data network (PDN) gateway (PGW) 120. Some embodiments of the PGW 120 provide connectivity between user equipment and external packet data networks. The PGW 120 may perform policy enforcement, packet filtering for the user equipment, charging support, lawful interception, and packet screening. The PGW 120 may also be an anchor for mobility between 3GPP and non-3GPP technologies.

The EPC 110 includes a mobility management entity (MME) 125. Some embodiments of the MME 125 are responsible for paging user equipment that are in the idle mode. The MME 125 participates in bearer activation/deactivation and is responsible for choosing a serving gateway at the initial attachment of user equipment to the wireless communication system 100. The MME 125 terminates non-access stratum (NAS) signaling for user equipment. The MME 125 may be the termination point for ciphering/integrity protection for NAS signaling in the wireless communication system 100 and may provide control plane functions for mobility between different network types. The MME 125 may also be responsible for authenticating user equipment by interacting with a Home Subscriber Server (HSS) 130 that is implemented in the EPC 110. The HSS 130 maintains a database that contains user-related and subscription-related information such as security keys used to establish secure associations between user equipment and the MME 125.

The EPC 110 also includes a policy control and charging rules function (PCRF) 135 that performs policy control decision-making and flow based charging control. Some embodiments of the PCRF 135 store information indicating data usage tariffs or charging policies. The charging policies may be determined based on a subscriber's charging account or an account associated with a group of subscribers. A policy and charging enforcement function (PCEF) 140 performs dataflow detection, policy enforcement, and flow-based charging, which may be based on the rules or policies provided by the PCEF 135. In the interest of clarity, interconnections that are used to carry information between entities within the EPC 110 such as the SGW 115, the PGW 120, the MME 125, the HSS 130, the PCRF 135, and the PCEF 140 are not shown in FIG. 1.

The wireless communication system 100 also includes an IP Multimedia Subsystem (IMS) 145 for delivering IP multimedia services or a packet-switched streaming service (PSS) to support transparent end-to-end transmission of packets in the wireless communication system 100. The IMS 145 includes one or more call session control functions (CSCF) 150 that are used to process signaling packets such as Session Initiation Protocol (SIP) signaling packets in the IMS 145. The CSCF 150 may include an interrogating-CSCF (I-CSCF) or a serving-CSCF (S-CSCF). Some embodiments of a S-CSCF act as a central node in the signaling plane that functions as a SIP server as well as performing session control. An HSS 155 is implemented in the IMS 145, and the S-CSCF uses interfaces to the HSS 155 to download user profiles, handle SIP registrations, provide routing services, and other functionality. Some embodiments of an I-CSCF are used as a forwarding point for SIP packets within its administrative domain. The I-CSCF can query the HSS 155 to receive the address of the S-CSCF and forward SIP requests or responses to the SCSCF, as well as perform other functions.

Gateways (GWs) 160, 161 provide an interconnection between the IMS 145 and the EPC 110. Some embodiments of the gateways 160, 161 may implement proxy CSCF (P-CSCF) functionality that provides a SIP proxy as a point of contact for terminals (such as user equipment 106, 107) to access the IMS 145. The gateways 160, 161 may also implement session border control (SBC) functionality or other gateway functionality.

One or more service centralization and continuity application servers (SCC-AS) 165, 166 are implemented in the IMS 145 to provide a session control in the IMS 145 for voice sessions originated or terminated by user equipment such as the user equipment 106, 107. The SCC-AS 165, 166 may mediate signaling such as SIP signaling that occurs from the establishment of a call between the user equipment 106, 107 to the termination of the call. For example, the SCC-AS 165, 166 may provide an interworking function for VoLTE calls. Different instances of the SCC-AS 165, 166 may be associated with different user equipment 106, 107.

One or more telecommunication application server (TASs) 170, 171 are implemented in the IMS 145 to provide services that can be used by voice, messaging, or video sessions for SIP subscribers in LTE and other wireless communication systems. For example, the TASs 170, 171 may be used to anchor VoLTE calls in the wireless communication system 100. Different instances of the TAS 170, 171 may be associated with different user equipment 106, 107.

Telephone number mapping is performed in the IMS 145 according to the E.164 Number Mapping (ENUM) standard. For example, the IMS 145 may implement an ENUM telephone number mapper 175. Some embodiments of the telephone number mapper 175 use domain name system (DNS) record types to translate a telephone number into a uniform resource identifier (URI) or IP address that can be used for Internet communications in the wireless communication system. For example, the telephone number mapper 175 may translate a telephone number of the user equipment 107 into an IP address in response to the user equipment 106 placing a VoLTE call to the user equipment 107 using the telephone number.

In order to establish a call with the user equipment 107, the user equipment 106 transmits a connection request over the air interface 108 to the base station 101 in the RAN 105. The base station 101 establishes a network connection (such as an RRC connection) with the user equipment 106 and initiates an inactivity timer 177 that is associated with the user equipment 106. The inactivity timer 177 may be set to a default value (such as 5 seconds for a default data bearer) and begins to count down once it has been initiated. The RRC connection with the user equipment 106 may be dropped upon expiry of the inactivity timer 177. The RAN 105 also identifies the destination user equipment 107, e.g., based on identifying information such as a phone number or IP address for the user equipment 107. A network connection such as an RRC connection is established between the base station 102 and the user equipment 107 over the air interface 109. An inactivity timer 178 is initiated to a default value (such as 5 seconds for a default data bearer) and begins to count, e.g., by counting down from the default value to zero. The inactivity timers 177, 178 may be implemented at any location within the RAN 105, including within the base stations 101, 102. The RRC connection with the user equipment 107 may be dropped upon expiry of the inactivity timer 178. In some embodiments, the network connections between the base stations 101, 102 and the user equipment 106, 107 may be established in response to other events and the inactivity timers 177, 178 may be initiated and begin to count down in response to establishment of the network connections. Although the inactivity timers 177, 178 count down from an initial value to zero to indicate expiry of the timer, some embodiments of the inactivity timers 177, 178 count up from an initial value of zero to a final value to indicate expiry of the timer or they may count from one non-zero value to another non-zero value to indicate expiry of the timer. In some cases, the inactivity timers 177, 178 may count to or through a rollover time.

The requested call between the user equipment 106, 107 is established based on signaling between entities in the EPC 110 and the IMS 145. In the illustrated embodiment, the RAN 105 transmits a request to establish the call along a path 180 that passes through the SGW 115 and the PGW 120 in the EPC 110. The MME 125, HSS 130, PCRF 135, and PCEF 140 may be used to configure a communication path 181 through the EPC 110 to a gateway 160 in the IMS 145 according to conventional techniques.

Signaling within the IMS 145 is then used to establish a call path 182 between the gateways 160, 161. In the illustrated embodiment, the gateway 160 provides signaling to the SCC-AS 165 associated with the user equipment 106 via the CSCF 150 along the path 183. The SCC-AS 165 is configured to mediate signaling such as SIP signaling for the user equipment 106 for the requested call and then provides an acknowledgment to the CSCF 150 along the path 184. The CSCF 150 notifies the TAS 170 of the request to establish the call along the path 185. The TAS 170 is configured to provide services in support of the call for the user equipment 106 based on the request and then provides an acknowledgment along the path 186. The telephone number mapper 175 receives information identifying the user equipment 107, translates the information into an IP address, and then returns the IP address of the user equipment 107 to the CSCF 150 along the path 187. The HSS 155 provides user profiles, SIP registration information, and routing services for the call along the path 188. The CSCF 150 notifies the TAS 171 of the request to establish the call along the path 189. The TAS 171 is configured to provide services in support of the call for the user equipment 107 based on the request and then provides an acknowledgment along the path 190. The CSCT 150 provides signaling to the SCC-AS 166 associated with the user equipment 107 along the path 191. Some embodiments of the SCC-AS 166 query the HSS 130 in the EPC 110 along the path 192 to verify that the user equipment 107 supports the requested call service, such as VoIP or VoLTE. The SCC-AS 166 is configured to mediate signaling such as SIP signaling for the user equipment 107 for the requested call and then provides an acknowledgment to the CSCF 150 and the gateway 161 along the path 193.

The EPC 110 receives the request to establish the call from the gateway 161 along a path 194 that passes through the SGW 115 and the PGW 120. The MME 125, HSS 130, PCRF 135, and PCEF 140 may be used to configure a communication path 195 from the gateway 161 through the EPC 110 to the RAN 105 according to conventional techniques. Once the call establishment process has successfully completed, the user equipment 106, 107 establish the requested call over a communication path 181 from the RAN 105 to the gateway 160, a communication path 182 from the gateway 162 the gateway 161, and from the gateway 162 to the RAN 105 over the communication path 195. Although the base stations 101, 102 are in the same RAN 105, this is not the case in all embodiments and other calls may be established between base stations in different RANs.

Establishment of the communication paths 181, 182, 195 results in transmission of signaling or messages over the air interfaces 108, 109 by the user equipment 106, 107. The signaling or messages create activity over the network connection and therefore cause the inactivity timers 177, 178 to be reset. A dedicated data bearer may be established to convey packets over the communication paths 181, 182, 195. Some embodiments of the RAN 105 may change the duration of the inactivity timers 177, 178 in response to establishment of the dedicated bearer. For example, the durations of the inactivity timers 177, 178 may be changed from a duration of 5 seconds for a default data bearer to a longer duration for a dedicated bearer, such as 20 seconds.

The inactivity timers 177, 178 may expire at different stages of the call establishment process. For example, delays during configuration of the various entities in the EPC 110 or the IMS 145 may delay establishment of the communication paths 181, 182, 195 long enough that one or more of the inactivity timers 177, 178 expires. For another example, once the communication paths 181, 182, 195 have been established and an alert (such as a ring or vibration or other user-detectable signal) is being provided to the user equipment 107, the user of the user equipment 107 may not respond before the inactivity timer 178 expires. Expiry of one or more of the inactivity timers 177, 178 causes the corresponding RRC connection to be dropped, which would cause the wireless communication system 100 to drop the requested call. For example, the user equipment 107 may drop the RRC connection over the air interface 109 and establish a new RRC connection with a base station 196 in a different network. The number of dropped calls may be reduced by globally increasing the default values of the inactivity timers 177, 178 for all applications and user equipment, but this would negatively impact the capacity of the wireless communication system 100.

The user equipment 106, 107 may therefore transmit a request to modify a duration of their associated inactivity timers 177, 178. Some embodiments of the request include an offset that can be added to the current or default value of the inactivity timers 177, 178. The corresponding base station 101, 102 receives the request to modify the duration of the inactivity timer 177, 178. The request is considered activity and consequently the corresponding inactivity timer 177, 178 is reset in response to receiving the request. The duration of the inactivity timer 177, 178 may also be changed by adding an offset included in the request to the current duration. The base station 101. 102 may then transmit a confirmation indicating that the duration of the inactivity timer 177, 178 has been modified. The user equipment 106, 107 receives the confirmation indicating that the duration of the inactivity timer 177, 178 has been modified.

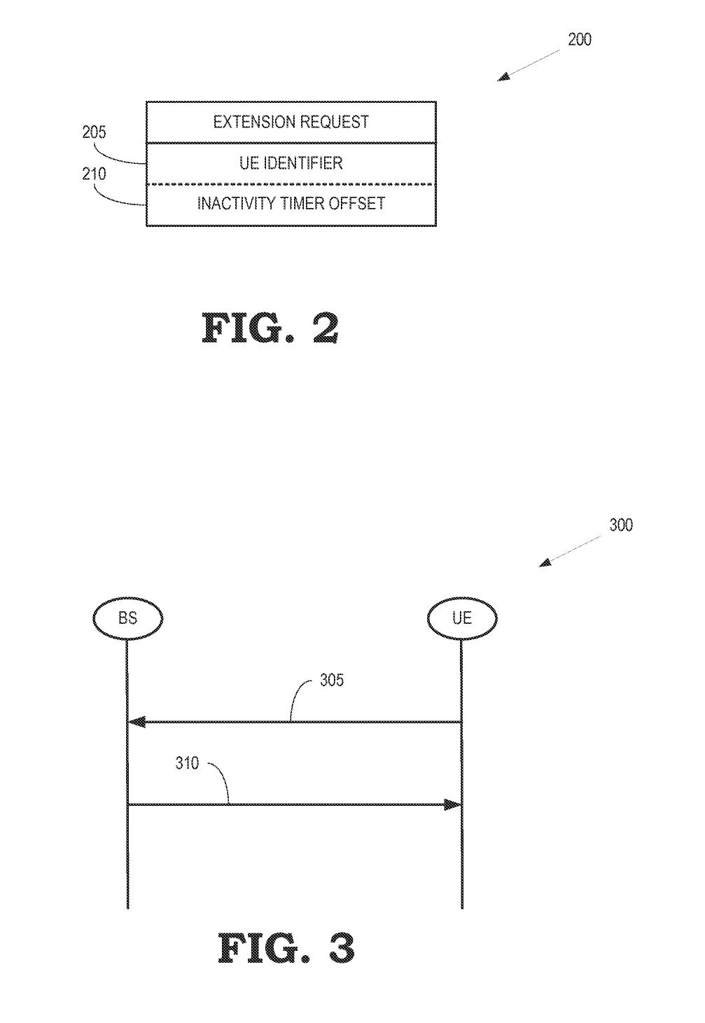

FIG. 2 is a diagram illustrating an extension request message 200 that is used to request a modification of an inactivity timer according to some embodiments. The extension request message 200 may be transmitted by some embodiments of the user equipment 106, 107 shown in FIG. 1. The extension request message 200 includes a field 205 that identifies the user equipment that is transmitting the request. The fields 205 may include information indicating a mobile station identifier, information identifying the network connection or RRC connection, or other identifying information. The extension request 200 may also include a field 210 including information indicating an inactivity timer offset that is to be added to the current duration of the inactivity timer associated with user equipment. For example, the field 210 may include an inactivity timer offset of 60 seconds to indicate that the receiving base station or RAN is to add 60 seconds to the current value of the inactivity timer associated with the user equipment. For another example, the field 210 may include an inactivity timer offset of -5 seconds to indicate that the receiving base station or RAN is to subtract five seconds from the current value of the inactivity timer associated with the user equipment.

The value of the inactivity timer offset indicated in the field 210 may be selected by the user equipment based on an application that is using the corresponding RRC connection. For example, the inactivity timer offset may be selected to have a positive value (such as 60 seconds) to provide additional time to complete a call connection to a user equipment, such as a VoIP or VoLTE call that involves multiple networks such as the EPC 110 and the IMS 145 shown in FIG. 1. For another example, the inactivity timer offset may be selected to have a negative value (such as −5 seconds) to reduce the time that the network has to wait before disconnecting an RRC connection for some MTC applications. Other MTC applications, such as public safety applications, may need to maintain the RRC connections over longer periods of inactivity and may therefore select larger values for the inactivity timer offset such as 140 seconds. In some embodiments, the value of the inactivity timer offset is set in response to event triggers. For example, the inactivity timer offset may be increased for a particular MTC application within an interval of time following an event that is detected by the user equipment.

FIG. 3 is a diagram illustrating an exchange 300 of an extension request and an acknowledgment according to some embodiments. The messages are exchanged between a base station (BS) and user equipment (UE) so the message exchange 300 may be implemented in some embodiments of the base stations 101, 102 or the user equipment 106, 107 shown in FIG. 1. The UE transmits an extension request message to the BS, as indicated by the arrow 305. Some embodiments of the extension request message use the format depicted in FIG. 2. The UE may transmit the extension request message in response to establishing a network connection such as an RRC connection that will be used to support an application such as a VoLTE call. The UE may also transmit the extension request message in response to other triggering events such as initiation of an MTC application. The BS response to the extension request message by transmitting an acknowledgment, as indicated by the arrow 310. The acknowledgment may indicate whether an inactivity timer associated with the UE has been successfully reset or modified based on an inactivity timer offset value included in the extension request message.

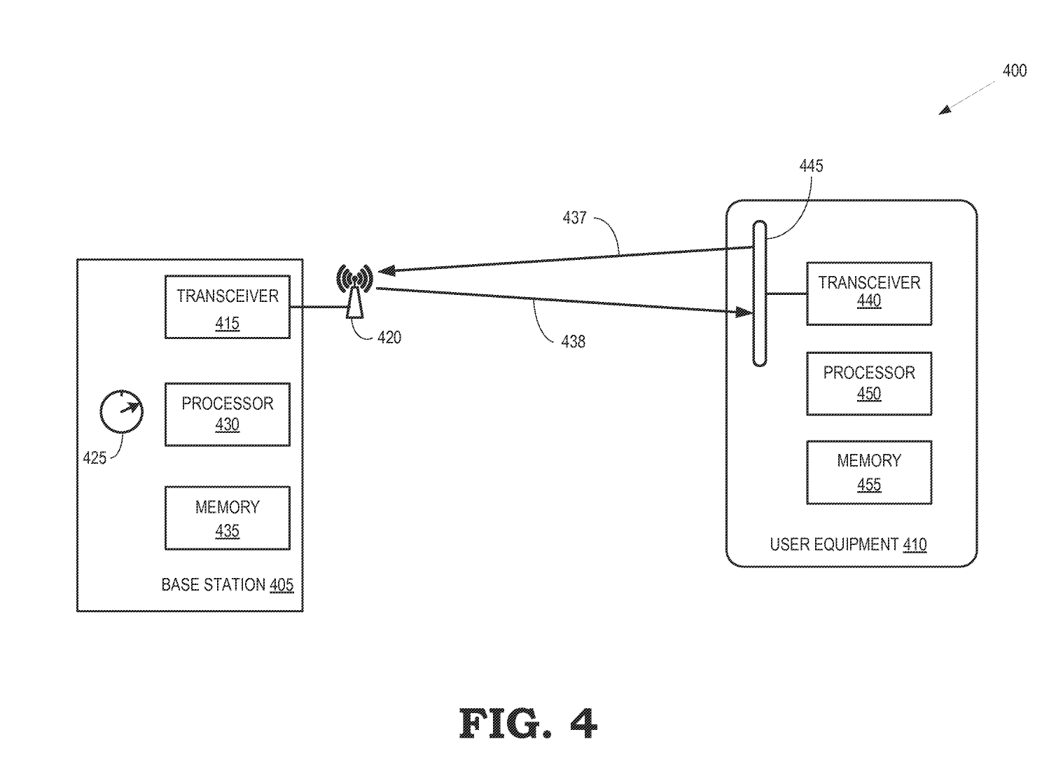

FIG. 4 is a block diagram of a wireless communication system 400 that supports wireless communication over an air interface according to some embodiments. The communication system 400 includes a base station 405 that supports wireless communication over an air interface with user equipment 410.

The base station 405 includes a transceiver 415 for transmitting and receiving signals using one or more antennas 420. The signals may include uplink or downlink signals transmitted over default data bearers or dedicated data bearers supported by the air interface. Some embodiments of the base station implement one or more inactivity timers 425 that count down a predetermined time interval while the associated user equipment 410 is inactive, as indicated by an absence of signaling or messages transmitted over the air interface. The base station 405 also includes a processor 430 and a memory 435. The processor 430 may be used to execute instructions stored in the memory 435 and to store information in the memory 435 such as the results of the executed instructions. The transceiver 415, the processor 430, and the memory 435 may be configured to perform some embodiments of the techniques described herein such as exchanging extension request messages 437 and acknowledgments 438 over an air interface and modifying a duration of an inactivity timer based on an inactivity timer offset.

The user equipment 410 includes a transceiver 440 for transmitting and receiving signals via antenna 445. The signals may include uplink or downlink signals transmitted over default data bearers or dedicated data bearers supported by the air interface. The user equipment 410 also includes a processor 450 and a memory 455. The processor 450 may be used to execute instructions stored in the memory 455 and to store information in the memory 455 such as the results of the executed instructions. The transceiver 440, the processor 450, and the memory 455may be configured to perform some embodiments of the techniques described herein such as selecting an inactivity timer offset and exchanging extension request messages 437 and acknowledgments 438 over the air interface.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
transmitting, from a user equipment, a request to modify a duration of an inactivity timer associated with the user equipment, wherein the inactivity timer is configured to count until being reset in response to the user equipment transmitting a message; and
receiving, at the user equipment, a confirmation indicating that the duration of the inactivity timer has been modified.

2. The method of claim 1, further comprising:
determining, at the user equipment, an offset to add to the duration of the inactivity timer.

3. The method of claim 2, wherein determining the offset comprises determining the offset based on at least one of an application executing on the user equipment and an event trigger detected by the user equipment.

4. The method of claim 2, wherein transmitting the request comprises transmitting a request including the offset.

5. The method of claim 4, wherein receiving the confirmation comprises receiving an indication that the inactivity timer has been reset in response to receiving the request and the duration of the inactivity timer has been modified based on the offset.

6. A method comprising:
receiving, at a base station, a first request to modify a duration of an inactivity timer associated with a user equipment, wherein the inactivity timer is configured to count until being reset in response to the base station receiving a message from the user equipment; and
transmitting, from the base station, a confirmation indicating that the duration of the inactivity timer has been modified.

7. The method of claim 6, further comprising:
modifying the duration of the inactivity timer associated with the user equipment in response to receiving the first request.

8. The method of claim 7, wherein modifying the duration of the inactivity timer comprises resetting the inactivity timer in response to receiving the first request.

9. The method of claim 8, wherein modifying the duration of the inactivity timer comprises resetting the inactivity timer to a modified duration that is equal to the duration plus an offset indicated by the first request.

10. The method of claim 7, further comprising:
initiating the inactivity timer in response to receiving a second request to initiate a communication session involving the user equipment, and wherein modifying the duration of the inactivity timer comprises modifying the duration of the inactivity timer in response to receiving the first request prior to expiry of the inactivity timer.

11. User equipment comprising:
a transceiver configured to transmit a request to modify a duration of an inactivity timer associated with the user equipment and receive a confirmation indicating that the duration of the inactivity timer has been modified, wherein the inactivity timer is configured to count until being reset in response to the user equipment transmitting a message.

12. The user equipment of claim 11, further comprising:
a processor to determine an offset to add to the duration of the inactivity timer.

13. The user equipment of claim 12, wherein the processor is to determine the offset based on at least one of an application executing on the user equipment and an event trigger detected by the user equipment.

14. The user equipment of claim 12, wherein the transceiver is to transmit the request including the offset.

15. The user equipment of claim 14, wherein the transceiver is to receive an indication that the inactivity timer has been reset in response to receiving the request and the duration of the inactivity timer has been modified based on the offset.

16. An apparatus comprising:
an inactivity timer associated with a user equipment; and
a transceiver to receive a first request to modify a duration of the inactivity timer and transmit a confirmation indicating that the duration of the inactivity timer has been modified, wherein the apparatus is to reset the inactivity timer in response to receiving a message from the user equipment.

17. The apparatus of claim 16, further comprising:
a processor to modify the duration of the inactivity timer associated with the user equipment in response to the transceiver receiving the first request.

18. The apparatus of claim 17, wherein the processor is to reset the inactivity timer in response to receiving the first request.

19. The apparatus of claim 18, wherein the processor is to reset the inactivity timer to a modified duration that is equal to the duration plus an offset indicated by the first request.

20. The apparatus of claim 19, wherein the processor is to initiate the inactivity timer in response to receiving a second request to initiate a communication session involving the user equipment, and wherein the processor is to modify the duration of the inactivity timer in response to the transceiver receiving the first request prior to expiry of the inactivity timer.
